(19) United States
(12) Patent Application Publication
(10) Pub. No.: US 2007/0204215 A1
(43) Pub. Date: Aug. 30, 2007

(54) Device for analyzing log files generated by process automation tools

(75) Inventors: Norbert Mueller, Munich (DE); Juergen Dirks, Holzkirchen (DE)

Correspondence Address: LSI CORPORATION, 1621 BARBER LANE, MS: D-106, MILPITAS, CA, 95035, US

(73) Assignee: LSI Logic Corporation

(21) Appl. No.: 11/364,142

(22) Filed: Feb. 27, 2006

(51) Int. Cl. G06F 17/00; G06F 7/00

(52) U.S. Cl. 715/514; 707/102; 707/100; 715/513

(57) ABSTRACT

A log file analysis device includes a partition of log file data generated by a process automation tool into a hierarchy of process data structures, a corresponding display object created for each of the process data structures, and a computer readable medium on which the corresponding display object is recorded. The corresponding display object instructs a computer to generate a child display of one of the process data structures in response to a selection of a process from a parent display.

### BACKGROUND OF THE INVENTION

1. Field of the Invention

The present invention is directed to the design and manufacture of integrated circuits. More specifically, but without limitation thereto, the present invention is directed to a method of displaying information in log files generated by various electronic design automation (EDA) programs typically used to design systems, software, and integrated circuits.

2. Description of Related Art

Electronic design automation (EDA) computer programs are typically used in an integrated circuit design environment. When applied to an integrated circuit design, EDA programs frequently generate log files that may exceed several megabytes in size. The log files usually include informational messages, warnings, and error messages in standard ASCII text format. In some cases, multiple log files are generated by the same EDA program. Also, different vendors may use different syntax and formats for different log files.

### SUMMARY OF THE INVENTION

In one embodiment, a log file display device includes:

a partition of log file data generated by a process automation tool into a hierarchy of process data structures;

a corresponding display object created for each of the process data structures; and

a computer readable medium on which the corresponding display object is recorded for instructing a computer to generate a child display of one of the process data structures from the corresponding display object in response to a selection of a process from a parent display.

In another embodiment, a method includes steps of:

(a) receiving as input log file data generated by a process automation tool;

(b) partitioning the log file data into hierarchy of process data structures;

(c) creating a corresponding display object for each of the process data structures; and

(d) recording the corresponding display object on a computer readable medium for instructing a computer to generate a child display from the corresponding display object in response to a selection of a process from a parent display.

In a further embodiment, a computer program product includes:

a medium for embodying a computer program for input to a computer; and

a computer program embodied in the medium for causing the computer to perform steps of:

(a) receiving as input log file data generated by a process automation tool;

(b) partitioning the log file data into hierarchy of process data structures;

(c) creating a corresponding display object for each of the process data structures; and

(d) generating a child display from the corresponding display object in response to a selection of a process from a parent display.

### BRIEF DESCRIPTION OF THE DRAWINGS

The above and other aspects, features and advantages will become more apparent from the description in conjunction with the following drawings presented by way of example and not limitation, wherein like references indicate similar elements throughout the several views of the drawings.

FIG. 1 illustrates a log file format for analyzing log file data generated by a process automation tool;

FIG. 2 illustrates a partition of log file data generated by a process automation tool into a hierarchy of process data structures in the log file format of FIG. 1;

FIG. 3 illustrates a display object created for a process data structure in the partition of FIG. 2;

FIG. 4 illustrates a processing summary display generated from the data display object of FIG. 3;

FIG. 5 illustrates a message summary display generated from the data display object of FIG. 3;

FIG. 6 illustrates an expanded message summary generated from the data display object of FIG. 3;

FIG. 7 illustrates a flow chart for a method of creating the data display object of FIG. 3; and

FIG. 8 illustrates a flow chart for a computer program product for analyzing log file data generated by a process automation tool.

Elements in the figures are illustrated for simplicity and clarity and have not necessarily been drawn to scale. For example, the dimensions, sizing, and/or relative placement of some of the elements in the figures may be exaggerated relative to other elements to clarify distinctive features of the illustrated embodiments. Also, common but well-understood elements that may be useful or necessary in a commercially feasible embodiment are often not depicted in order to facilitate a less obstructed view of the illustrated embodiments.

### DESCRIPTION OF THE ILLUSTRATED EMBODIMENTS

The following description is not to be taken in a limiting sense, rather for the purpose of describing by specific examples the general principles that are incorporated into the illustrated embodiments. For example, certain actions or steps may be described or depicted in a specific order to be performed. However, practitioners of the art will understand that the specific order is only given by way of example and that the specific order does not exclude performing the described steps in another order to achieve substantially the same result. Also, the terms and expressions used in the description have the ordinary meanings accorded to such terms and expressions in the corresponding respective areas of inquiry and study except where other meanings have been specifically set forth herein.

Log files generated by process automation tools, for example, electronic design automation (EDA) programs, can provide useful information to assist designers in identifying and correcting problems in system designs, in software designs, and in integrated circuit designs. Because the log files are usually generated in ASCII text format, text viewers are typically used by the designer or engineer to search log files for specific relevant information, such as error messages. Disadvantageously, the size of a log file generated by process automation tools that perform a large number of processes cases may exceed the capacity of common text viewers, and the limited search methods available for text files may not find all the information related to a specific aspect of the design being searched. Also, EDA program vendors use different formats of ASCII text characters and lines to generate log file data. As a result, different search methods are needed to accommodate each different format, and users have had to write post-processing software to find certain items of information in log files.

In a typical integrated circuit design, the log file may extend for thousands of pages, which makes comprehension of the overall process organization impractical for a circuit designer. Consequently, searching the log file for a specific area of interest in the process flow becomes extremely time-consuming.

The disadvantages of the different formats used by EDA vendors may be overcome by arranging the often overwhelming amount of log file data into a format that may be readily partitioned into convenient, browsable files to assist the user in navigating specific areas of interest in the log file data as follows.

In one embodiment, a log file display device includes:

a partition of log file data generated by a process automation tool into a hierarchy of process data structures;

a corresponding display object created for each of the process data structures; and

a computer readable medium on which the corresponding display object is recorded for instructing a computer to generate a child display of one of the process data structures from the corresponding display object in response to a selection of a process from a parent display.

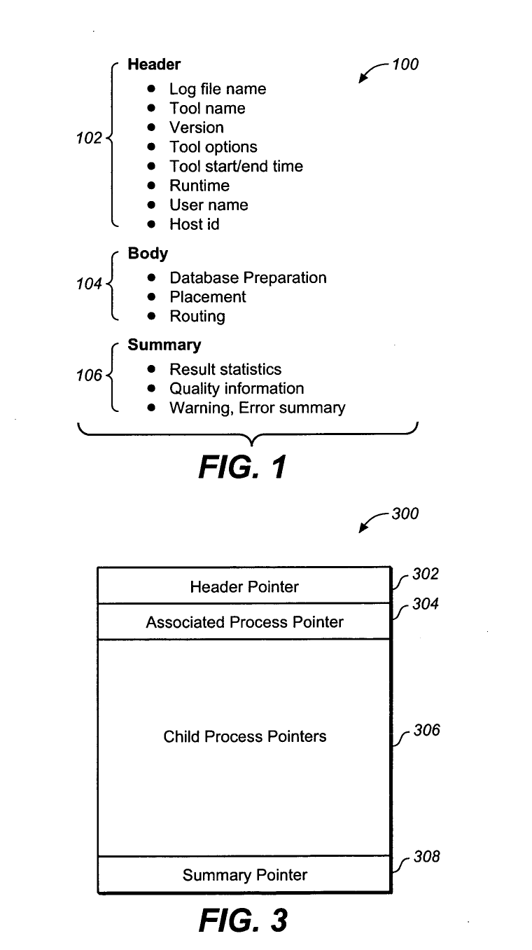

FIG. 1 illustrates a log file format 100 for analyzing log file data generated by a process automation tool. Shown in FIG. 1 are a header portion 102, a body portion 104, and a summary portion 106.

The header portion 102 includes a general description of the process, for example, a log file name, a tool name, a version number, a tool start time, a tool end time, a tool setting, a tool default option, a user name, a host identifier, and other information.

The body portion 104 includes a list of processes that are included in the process, for example, input data reading, syntax checking, database preparation, and optimization.

The summary portion 106 includes results of the process, for example, statistics for the selected process, information about quality of the results, a warning summary, and an error summary.

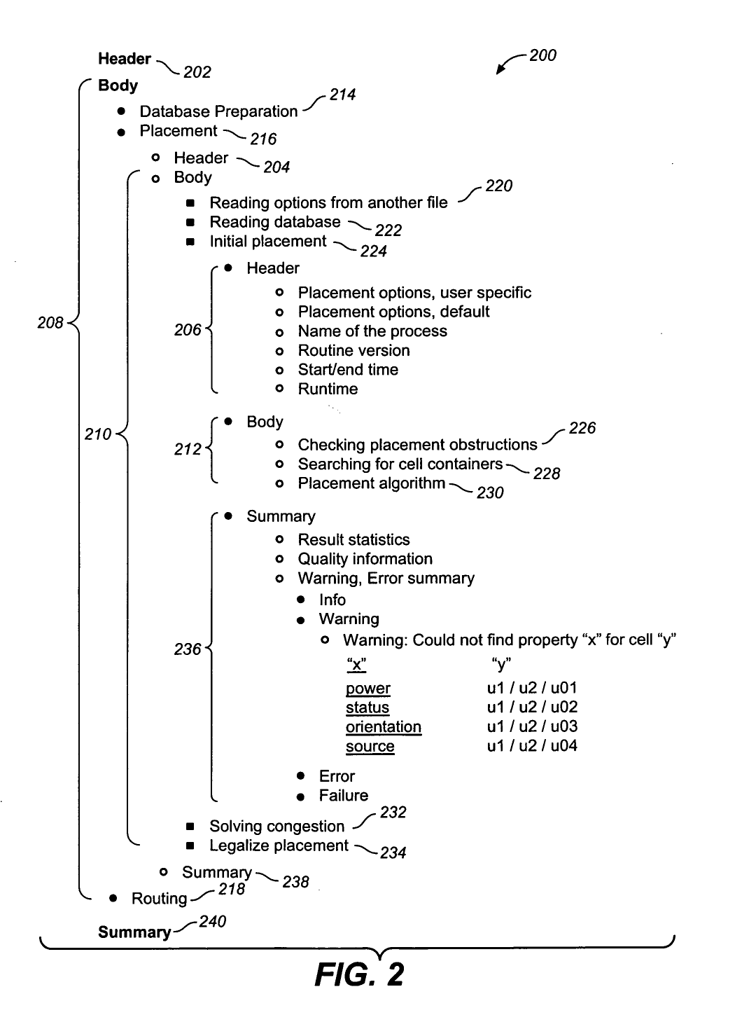

FIG. 2 illustrates a partition of log file data generated by a process automation tool into a hierarchy of process data structures 200 in the log file format of FIG. 1. Shown in FIG. 2 are header portions 202, 204, and 206, body portions 208, 210, and 212, processes 214, 216, 218, 220, 222, 224, 226, 228, 230, 232, and 234, and summary portions 236, 238, and 240.

A typical process automation tool includes a root process that invokes a number of child processes in a tree structure, or hierarchy of processes. Each child process invokes a number of other child processes, and so on, until each branch of the tree terminates in a leaf process. A leaf process includes one or more individual steps that do not invoke any further processes. In FIG. 2, the root process is included in the body portion 208. The body portion 208 lists the child processes 214, 216, and 218. The body portion 210 of the child process 216 list the child processes 220, 222, 224, 232, and 234. The body portion 212 of the child process 224 lists the child processes 226, 228, and 230. The hierarchical format of the log file data in FIG. 2 may be constructed from the flattened log file data generated by the automated process tool, for example, according to well known programming techniques.

FIG. 3 illustrates a display object 300 created for a process data structure in the partition of FIG. 2. Shown in FIG. 3 are a header pointer 302, an associated process pointer 304, child process pointers 306, and a summary process pointer 308.

In FIG. 3, the log file data is partitioned into a hierarchy of process data structures including a corresponding display object 300 for each of the process data structures. In one embodiment, each display object 300 includes the header pointer 302, the associated process pointer 304, child process pointers 306, and the summary process pointer 308. The header pointer 302 links to the header portion of the process associated with the display object 300. For example, the process associated with the display object 300 may be the process 224 in FIG. 2. Accordingly, the associated process pointer 304 links to the process 224, and the header pointer 302 links to the header portion 206. The child process pointers 306 link to the child processes 226, 228, and 230. The summary process pointer 308 links to the summary portion 236. A corresponding data object is created in the same manner for each process in the hierarchy of process data structures. Other devices than the example of FIG. 3 may be used to create data objects for invoking a child display, for example, according to well-known object oriented programming techniques.

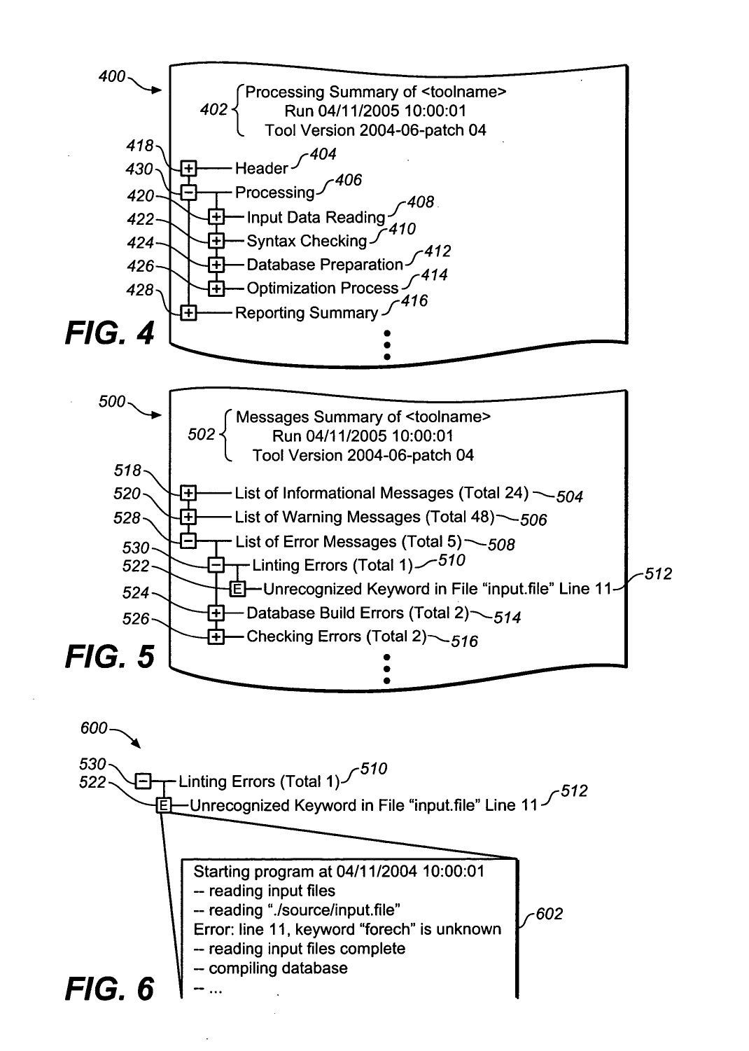

FIG. 4 illustrates a processing summary display 400 generated from the data display object of FIG. 3. Shown in FIG. 4 are a display title 402, display subtitles 404, 406, 408, 410, 412, 414, and 416, expansion icons 418, 420, 422, 424, 426, and 428, and a reduction icon 430.

In FIG. 4, the display title 402 identifies the process automation tool from the information included in the header portion of the process data structure. The display subtitle 404 displays the header portion of the process associated with the process data structure. The display subtitle 406 displays the body portion of the process associated with the data object. The display subtitles 408, 410, 412, and 414 list the processes that are included in the process associated with the process data structure. The display subtitle 416 displays the summary portion of the process data structure. The expansion icons 418, 420, 422, 424, 426, and 428 may be selected to expand the contents of the display subtitles 404, 408, 410, 412, 414, and 416, and the reduction icon 430 may be selected to hide the contents of the subtitle 406. In the illustrated embodiment, the expansion icon is a “+”, and the reduction icon is a “−”; however, other symbols may be used to indicate the expansion icons and the reduction icons to practice various embodiments within the scope of the appended claims. Also, the fonts, style, and arrangement of the text and icons shown in the processing summary display 400 may be varied according to well-known display techniques to practice other embodiments within the scope of the appended claims.

In operation, the display object corresponding to the root process is displayed in a parent display to the user, for example, a circuit designer. In the example of FIG. 4, the display subtitle 406 is shown initially in expanded format, while the display subtitles 404, 408, 410, 412, 414, and 416 are shown in reduced format. A default selection of which display subtitles to display in expanded format and which display subtitles to display in reduced format may be made, for example, by including a default mask in the log file data. In another embodiment, the user may override the default mask with the user's preference.

Each of the expansion icons 418, 420, 422, 424, 426, and 428 may be selected by the user to invoke a child display of the contents of a display subtitle and follow the successive child displays to traverse the hierarchy of processes from the root process to a leaf process. In this manner, the user may traverse the process hierarchy from a single page display through extremely complex process hierarchies while maintaining an overview of the high level organization of the log file data.

FIG. 5 illustrates a message summary display 500 generated from the data display object of FIG. 3. Shown in FIG. 5 are a display title 502, display subtitles 504, 506, 508, 510, 512, 514, and 516, expansion icons 518, 520, 522, 524, and 526, and reduction icons 528 and 530.

In FIG. 5, the display title 502 identifies the process automation tool from the information included in the summary portion of the display object. The display subtitles 504, 506, and 508 identify lists of messages in the informational, warning, and error categories generated by the process automation tool in the log file data. The expansion icons 518, 520, 522, 524, and 526 may be selected to expand the contents of the display subtitles 504, 506, 512, 514, and 516, and the icons 528 and 530 may be selected to hide the contents of the display subtitles 508 and 510. In the illustrated embodiment, the expansion icons are the symbols “+” and “E”, and the reduction icon is the symbol “−”; however, other symbols may be used to indicate the expansion icons and the reduction icons to practice various embodiments within the scope of the appended claims. Also, the fonts, style, and arrangement of the text and icons shown in the message summary display 500 may be varied according to well-known display techniques to practice various embodiments within the scope of the appended claims.

In the example of FIG. 5, the display subtitle 508 is shown initially in partially expanded format, while the other display subtitles are shown in reduced format. A default selection of which display subtitles to display in expanded format and which display subtitles to display in reduced format may be made, for example, by including a default mask in the log file data. In another embodiment, the user may override the default mask with the user's preference.

Each of the expansion icons 518, 520, 522, 524, and 526 may be selected by the user to invoke a child display of the message contents from a message identified by the display subtitle. In this manner, the user may traverse extremely complex process hierarchies from a single page display that provides an overview of the high level organization of the log file data.

FIG. 6 illustrates an expanded message summary generated from the data display object of FIG. 3. Shown in FIG. 6 are display subtitles 510 and 512, an expansion icon 522, a reduction icon 530, and a message 602.

In FIG. 6, the message 602 under the display subtitle 512 is displayed when the user selects the expansion icon 522. In this example, the message 602 specifies an unrecognized keyword in an input file.

Other types of display objects may be created in the same manner as described above for debugging inside an automation tool, that is, to identify cells that are causing certain types of errors and to continue the process flow if no errors occur. If no errors occur, then the informational messages may be viewed before continuing the process flow.

In another embodiment, direct links from messages in the log file data to user manual documents may be provided according to well-known techniques to allow a user to link to a related detailed explanation in the process automation tool manual pages. For example, the messages in the log file data may be expressed as interactive hyperlinks. A hyperlink, or simply a link, is a reference to another document or other resource, similar to a citation in a research paper. Combined with a data network and suitable access protocol, a computer may be instructed to fetch the resource referenced by the hyperlink.

In a further embodiment, log files generated by various process automation tools may be converted to a standard format such as illustrated in FIG. 2 by a standalone or embedded format conversion tool so that the log file analysis device described above may be used directly with existing process automation tools.

In another embodiment, a method includes steps of:

(a) receiving as input log file data generated by a process automation tool;

(b) partitioning the log file data into hierarchy of process data structures;

(c) creating a corresponding display object for each of the process data structures; and

(d) recording the corresponding display object on a computer readable medium for instructing a computer to generate a child display from the corresponding display object in response to a selection of a process from a parent display.

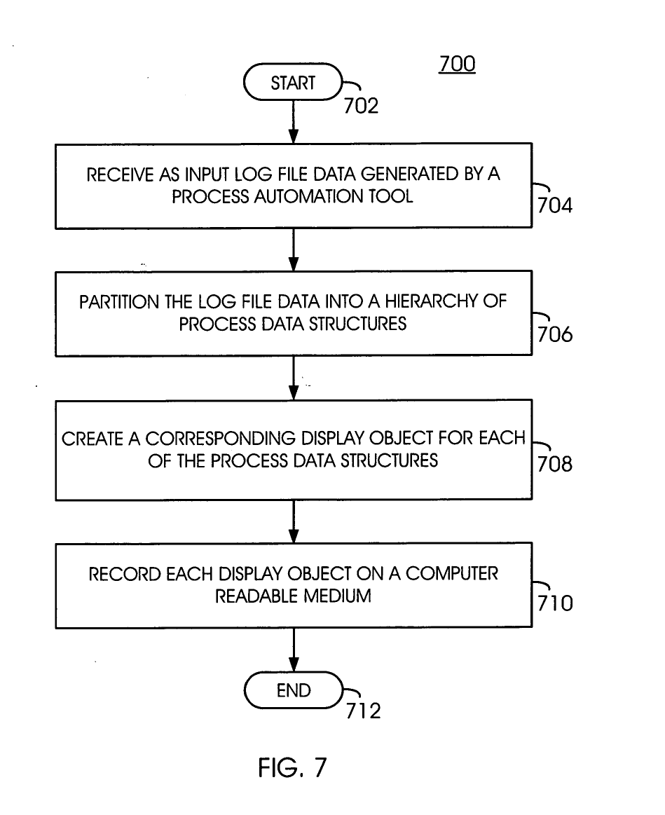

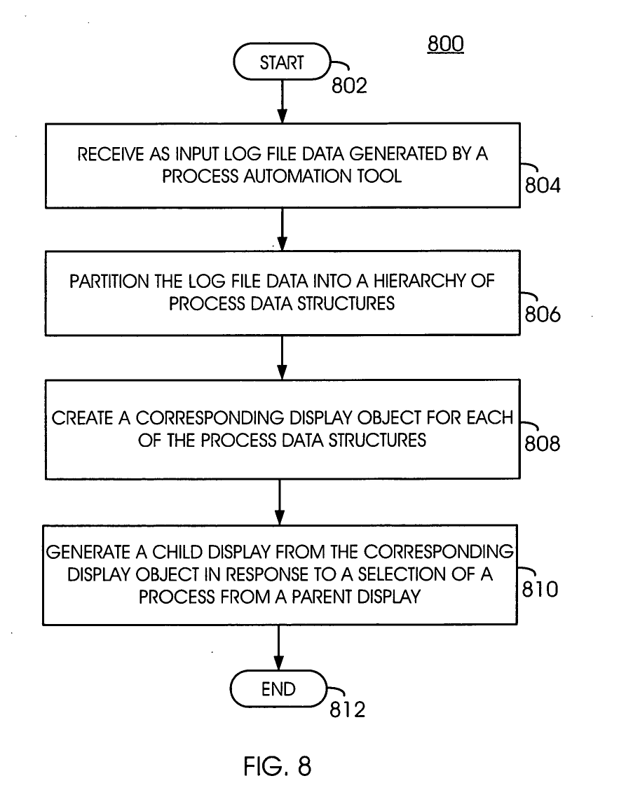

FIG. 7 illustrates a flow chart 700 for a method of creating the data display object of FIG. 3.

Step 702 is the entry point of the flow chart 700.

In step 704, log file data generated by a process automation tool is received as input. Examples of process automation tools include electronic design automation (EDA) tools, for example, placement and routing tools. Other embodiments may be practiced within the scope of the appended claims for other computer aided design (CAD) tools, for example, printed circuit board design tools, to design and manufacture a variety of products. The term process automation tool includes any set of steps used to design or manufacture a product by a computer. Typically, process automation tools are embodied in computer programs. In the illustrated examples, the product to be designed or manufactured is an integrated circuit.

In step 706, the log file data is partitioned into a hierarchy of process data structures as described above with reference to FIG. 2.

In step 708, a corresponding display object is created for each of the process data structures. In one embodiment, each display object includes pointers to the header portion, the body portion, and the summary portion of a process in the log file data. The header portion identifies the process, or parent process. The body portion lists one or more processes that are included in the parent process, that is, the child processes. A process that does not include any further processes is called a leaf process. The summary portion includes information resulting from the parent process, such as warnings and error messages. In other embodiments, the display object may be a hyperlink in hypertext markup language (HTML), PDF, or LISP format.

Each display object instructs a computer program to display a child display in response to a selection of a process identified in the list of processes from a parent display. For example, if a parent display shows a list of processes that includes process Q, process R, and process S, then a user may select process R. The selection of process R invokes a child display that includes a list of processes performed by process R, for example, process J and process L. If the user selects process J, then the child display becomes the parent display that invokes the child display that lists the processes performed by process J. If the list of processes for process J is empty, then process J is a leaf process. Each display in the succession of child displays includes a list of processes from which the next child display may be selected, until the list of processes in the last child display is empty. In this manner, the user can navigate the log file data from the root process to a leaf process from a series of displays that range from a macroscopic view to a microscopic view. Advantageously, this arrangement allows the user to trace a process of interest without having to search through unrelated processes in the log file data, resulting in a substantial savings in time required to analyze process results. In one embodiment, each leaf process itemizes the individual step or steps that are performed by the selected process.

In step 710, each display object is recorded on a computer readable medium, for example, in a hypertext markup language (HTML) file according to well-known computer programming techniques. The HTML file may be read by an HTML browser such as Netscape or Internet Explorer. In another embodiment, each display object is recorded on a computer readable medium in a PDF file that may be read, for example, by Acrobat Reader. In a further embodiment, each display object is recorded on a computer readable medium in a LISP file in that may be read, for example, by a LISP text editor such as Emacs (Editor MACroS). Other file formats may be used to record the display objects and read by a computer program to display interactive hyperlinks for navigating the log file data to a specific area of interest in other embodiments within the scope of the appended claims.

Step 712 is the exit point of the flow chart 700.

The flow chart described above with reference to FIG. 2 may also be automated by instructions for a computer. The instructions may be embodied in a disk, a CD-ROM, and other computer readable media according to well known computer programming techniques.

In another embodiment, a computer program product includes:

a medium for embodying a computer program for input to a computer; and

a computer program embodied in the medium for causing the computer to perform steps of:

(a) receiving as input log file data generated by a process automation tool;

(b) partitioning the log file data into hierarchy of process data structures;

(c) creating a corresponding display object for each of the process data structures; and

(d) generating a child display from the corresponding display object in response to a selection of a process from a parent display.

FIG. 8 illustrates a flow chart for a computer program product for analyzing log file data generated by a process automation tool.

Step 802 is the entry point of the flow chart 800.

In step 804, log file data generated by a process automation tool is received as input. For example, the process automation tool may be an electronic design automation (EDA) tool typically employed in the design of integrated circuits. Other process automation tools that generate log file data in the design and manufacture of a variety of electronic and non-electronic products, computer software, and systems may be used to practice various embodiments of the present within the scope of the appended claims.

In step 806, the log file data is partitioned into hierarchy of process data structures. In one embodiment, each of the process data structures includes a header portion, a body portion, and a summary portion. The header portion identifies a process associated with the process data structure, that is, a parent process. The body portion includes a list of processes that are included in the process associated with the process data structure, that is, child processes. The summary portion includes information resulting from performing the parent process, such as warnings and error messages.

In step 808, a corresponding display object is created for each of the process data structures. The corresponding display object includes information for instructing a computer to generate a child display for each of the child processes. The child display then becomes the next parent display, and so on, until the child display displays a leaf process, that is, a process that does not include any further processes. A child display is generated as output from the corresponding display object in response to a selection of a process from a parent display.

In step 810, a child display is generated from the corresponding display object in response to a selection of a process from a parent display. In this manner, a user may navigate the process hierarchy from the root process to a leaf process without sorting through processes that are not in the path of interest.

Step 812 is the exit point of the flow chart 800.

As may be appreciated from the above, the disadvantages of the previous methods used for finding information in EDA log files may be overcome by formatting EDA log files in a common standard, for example, HTML and PDF formats, that may be accommodated by readily available viewers to provide more advanced text handling and analyzing capabilities than plain text viewers. For example, by formatting the log files in HTML, a interactive hyperlinks may be used to display a summary of the log file on a single page. Each heading in the summary may be expanded by clicking the hyperlink to display more detailed levels until the desired item of information is found. As a result, the time required to find specific information in a large log file may be greatly reduced, as well as the likelihood of overlooking an important item of information.

Although the flowchart descriptions above are described and shown with reference to specific steps performed in a specific order, these steps may be combined, sub-divided, or reordered without departing from the scope of the claims. Unless specifically indicated, the order and grouping of steps is not a limitation of other embodiments that may lie within the scope of the claims.

The specific embodiments and applications thereof described above are for illustrative purposes only and do not preclude modifications and variations that may be made within the scope of the following claims.

What is claimed is:

1. A log file analysis device comprises:
a partition of log file data generated by a process automation tool into a hierarchy of process data structures;
a corresponding display object created for each of the process data structures; and
a computer readable medium on which the corresponding display object is recorded for instructing a computer to generate a child display of one of the process data structures from the corresponding display object in response to a selection of a process from a parent display.

2. The log file analysis device of claim 1 wherein each of the process data structures includes a header portion, a body portion, and a summary portion.

3. The log file analysis device of claim 2 wherein the header portion includes a general description of the process.

4. The log file analysis device of claim 3 wherein the general description includes at least one of a log file name, a tool name, a version number, a tool start time, a tool end time, a tool setting, a tool default option, a user name, and a host identifier.

5. The log file analysis device of claim 2 wherein the body portion includes a list of processes that are performed by the process.

6. The log file analysis device of claim 5 wherein the body portion itemizes at least one individual step performed by the process.

7. The log file analysis device of claim 2 wherein the summary portion includes results information for the process.

8. The log file analysis device of claim 7 wherein the results information of the process includes at least one of process statistics, process quality, a warning summary, and an error summary.

9. The log file analysis device of claim 1 wherein the child display is generated in response to selecting an expansion icon from the parent display.

10. The log file analysis device of claim 1 wherein the parent display is generated in response to selecting a reduction icon from the child display.

11. The log file analysis device of claim 1 wherein the display object has a format that is compatible with a browser for generating one of the parent display and the child display from the display object.

12. The log file analysis device of claim 11 wherein the browser is one of an HTML browser, a PDF reader, and a LISP text editor.

13. The log file analysis device of claim 1 further comprising a mask for selecting whether to display a portion of the child display in an expanded form or in a non-expanded form.

14. The log file analysis device of claim 1 wherein the process automation tool is an electronic design automation tool.

15. A method comprising steps of:
(a) receiving as input log file data generated by a process automation tool;
(b) partitioning the log file data into hierarchy of process data structures;
(c) creating a corresponding display object for each of the process data structures; and
(d) recording the corresponding display object on a computer readable medium for instructing a computer to generate a child display from the corresponding display object in response to a selection of a process from a parent display.

16. The method of claim 15 further comprising a step of including a header portion, a body portion, and a summary portion in each of the process data structures.

17. The method of claim 16 further comprising a step of including a general description of the process associated with the corresponding display object in the header portion.

18. The method of claim 17 further comprising a step of including at least one of a log file name, a tool name, a version number, a tool start time, a tool end time, a tool setting, a tool default option, a user name, and a host identifier in the general description.

19. The method of claim 16 further comprising a step of including in the body portion a list of processes that are included in the process.

20. The method of claim 19 further comprising a step of itemizing at least one individual step performed by the process in the body portion.

21. The method of claim 16 further comprising a step of including results information of the process in the summary portion.

22. The method of claim 21 further comprising a step of including in the results information at least one of process statistics, process quality, a warning summary, and an error summary.

23. The method of claim 15 further comprising a step of generating the child display in response to selecting an expansion icon from the parent display.

24. The method of claim 15 further comprising a step of generating the parent display in response to selecting a reduction icon from the child display.

25. The method of claim 15 further comprising a step of generating one of the parent display and the child display from the corresponding display object with a browser.

26. The method of claim 25 further comprising a step of generating one of the parent display and the child display from the corresponding display object with one of an HTML browser, a PDF reader, and a LISP text editor.

27. The method of claim 26 further comprising a step of selecting an option whether to display a portion of the child display in an expanded form or in a non-expanded form from a mask.

28. A computer program product comprising:
a medium for embodying a computer program for input to a computer; and
a computer program embodied in the medium for causing the computer to perform steps of:
(a) receiving as input log file data generated by a process automation tool;
(b) partitioning the log file data into hierarchy of process data structures;
(c) creating a corresponding display object for each of the process data structures; and
(d) generating a child display from the corresponding display object in response to a selection of a process from a parent display.

29. The computer program product of claim 28 further comprising a step of including a header portion, a body portion, and a summary portion in each of the process data structures.

30. The computer program product of claim 29 further comprising a step of including a general description of the process in the header portion.

31. The computer program product of claim 30 further comprising a step of including at least one of a log file name, a tool name, a version number, a tool start time, a tool end time, a tool setting, a tool default option, a user name, and a host identifier in the general description.

32. The computer program product of claim 29 further comprising a step of including in the body portion a list of processes that are included in the process.

33. The computer program product of claim 29 further comprising a step of itemizing at least one individual step performed by the process in the body portion.

34. The computer program product of claim 29 further comprising a step of including results information of the process in the summary portion.

35. The computer program product of claim 34 further comprising a step of including in the results information at least one of process statistics, process quality, a warning summary, and an error summary.

36. The computer program product of claim 28 further comprising a step of generating the child display in response to selecting an expansion icon from the parent display.

37. The computer program product of claim 28 further comprising a step of generating the parent display in response to selecting a reduction icon from the child display.

38. The computer program product of claim 28 further comprising a step of generating one of the parent display and the child display from the corresponding display object with a browser.

39. The computer program product of claim 38 further comprising a step of generating one of the parent display and the child display from the corresponding display object with one of an HTML browser, a PDF reader, and a LISP text editor.

40. The computer program product of claim 29 further comprising a step of selecting an option whether to display each of the header portion, the body portion, and the summary portion in an expanded form or a non-expanded form from a mask.
